(19) United States
(12) Patent Application Publication
(10) Pub. No.: US 2021/0143471 A1
(43) Pub. Date: May 13, 2021

(54) Printable Solid Electrolyte for Flexible Lithium Ion Batteries

(71) Applicant: Nano and Advanced Materials Institute Limited, Hong Kong (HK)

(72) Inventors: Sara ABOUALI, Hong Kong (HK); Fulin ZHENG, Hong Kong (HK); Li FU, Hong Kong (HK)

(21) Appl. No.: 17/153,887

(22) Filed: Jan. 21, 2021

Related U.S. Application Data
(62) Division of application No. 16/217,001, filed on Dec. 11, 2018.
(60) Provisional application No. 62/708,566, filed on Dec. 14, 2017.

(51) Int. Cl. H01M 10/0562; H01M 10/058; H01M 10/0525; H01M 10/056; H01M 50/403; H01M 50/446

(52) U.S. Cl. CPC H01M 10/0562; H01M 10/058; H01M 10/0525; H01M 10/0565; H01M 50/403; H01M 50/446; H01M 10/056

(57) ABSTRACT

A UV-curable and printable combination separator and solid electrolyte precursor material for lithium ion batteries is provided. The precursor material includes a lithium salt dissolved in one or more organic solvents. A UV-curable monomer is included in an amount from approximately 4 weight percent to approximately 10 weight percent along with a UV-initiator. One or more host ion conductive polymers are provided in an amount less than approximately 5 weight percent of the precursor material and a ceramic powder. The precursor material, when cured, has sufficient mechanical rigidity to act as a separator preventing electrical shorting between a lithium ion battery cathode and a lithium ion battery anode. It also has sufficient electrical conductivity to function as an electrolyte for a lithium ion battery. A method for making a lithium ion battery is also provided where printing allows the formation of batteries with complex shapes.

### CROSS-REFERENCE TO RELATED APPLICATIONS

The present application is a division of the U.S. non-provisional patent application Ser. No. 16/217,001 filed Dec. 11th, 2018, which claims priority from the U.S. provisional patent application Ser. No. 62/708,566 filed Dec. 14th, 2017, and the disclosures of which are incorporated herein by reference in their entirety.

### FIELD OF THE INVENTION

The present invention relates to printable solid electrolytes and, more particularly, to printable solid electrolytes for lithium ion batteries that obviate the need for separators.

### BACKGROUND

There is an ever-increasing demand for high performance lithium ion batteries. New classes of flexible and wearable electronics has fueled research into smaller form-factor batteries. One of the concerns in industry is to develop flexible batteries with high levels of safety, especially at elevated temperatures. In particular, the safety of conventional liquid electrolytes has been examined. At high temperatures, electrolyte leakage may lead to fire or explosion. Therefore, solid electrolytes have been investigated as an alternative to liquid electrolytes.

In the past, polymeric electrolytes have primarily been solid polymer membranes. These polymer membranes require an extra activation step in which the membrane is soaked in a liquid electrolyte before assembly into a battery. Another approach uses viscous polymer electrolyte with better wettability; however, the mechanical strength is not sufficient to prevent shorting between a cathode and an anode without a separator. Further, the use of solid electrolytes may worsen battery performance due to lower ionic conductivity and wettability compared to liquid electrolytes.

In U.S. Pat. No. 4,792,50 a liquid-containing polymer network is used as a solid electrolyte. It includes a cross-linked PEO network, a metal salt and a dipolar solvent. After choosing appropriate solvents to dissolve the polymers and metal salts, a curing step is necessary to evaporate the polymer solvent to get an electrolyte film having a low ionic conductivity of 2×10⁻⁵ S/cm at room temperature.

U.S. Pat. No. 8,889,301 discloses a gel polymer electrolyte comprising a block copolymer having a gelled region for ion flow and a rigid region for mechanical support; it includes a Li salt dissolved in a solvent. Various complicated processes are performed in order to synthesize the block copolymer. The final film can be obtained through compression molding and a battery can be assembled by sandwiching this layer between positive and negative electrodes.

WO/2013169370 discloses a solid electrolyte film comprising a mixture of polyoctahedral silsesquioxane-phenyl₇(BF₃Li)₃ and PEO. Since the final product is a hard solid film, it cannot be used as a printable electrolyte and the ionic conductivity at ambient temperature is also low.

In 2015, Lee et. Al, Nano Lett. 2015, Vol. 15, pp. 5168-5177, reported a solid-state shape conformable Li-ion battery using a UV-curable electrolyte. The electrolyte matrix is mixed with cathode and anode electrodes which can improve the kinetics of Li-ion transport. Anode, cathode and electrolyte are all stencil printed followed by a UV irradiation step after each printing. All of the steps should be carried out inside the glove box which makes the process difficult. Because the electrolyte matrix is mixed with the cathode and anode pastes, the process is more complex.

NEI Corporation has developed both polymer based solid electrolytes and inorganic solid electrolytes including superionic conducting oxide or sulfide based materials. The first group is a solid polymer film with lithium ionic conductivity approaching 10⁻⁴ S/cm, while this value reaches to 10⁻⁴-10⁻² S/cm at room temperature for the second group. However, the production cost for inorganic solid electrolytes is very high.

SEEO Inc. has introduced a solid electrolyte, DryLyte, which is a polymer-based layer coated on the electrode surface followed by a thermal curing process.

Ionic Materials has developed a solid polymer electrolyte film comprising an ionic compound mixed with a conductive polymer. Room temperature ionic conductivity of 1.3×10⁻³ S/cm.

There remains a need in the art for UV-curable and printable materials to create solid layers which can act as both an electrolyte and as a separator for lithium ion batteries.

### Summary

A UV-curable and printable combination separator and solid electrolyte precursor material for lithium ion batteries is provided. The precursor material includes a lithium salt dissolved in one or more organic solvents. A UV-curable monomer is included in an amount from approximately 4 weight percent to approximately 10 weight percent along with a UV-initiator. One or more host ion conductive polymers are provided in an amount less than approximately 5 weight percent of the precursor material and a ceramic powder. The precursor material, when cured, has sufficient mechanical rigidity to act as a separator preventing electrical shorting between a lithium ion battery cathode and a lithium ion battery anode. It also has sufficient electrical conductivity to function as an electrolyte for a lithium ion battery. A method for making a lithium ion battery is also provided where printing allows the formation of batteries with complex shapes.

### BRIEF DESCRIPTION OF THE DRAWINGS:

FIG. 1 schematically depicts a solid electrolyte according to an aspect of the present invention;

FIG. 2 is a cross-section of a battery incorporating the solid electrolyte of FIG. 1;

FIG. 3 shows an electrochemical impedance spectroscopy (EIS) curve for ionic conductivity measurement;

FIG. 4 shows a charge/discharge curve of a solid state Li-ion cell made with the solid electrolyte layer of FIG. 1.

### DETAILED DESCRIPTION

Turning to the drawings in detail, FIG. 2 depicts a lithium ion battery 100 having no separator between the electrodes. Battery 100 includes a cathode 110, a solid electrolyte layer 120, and an anode 130. In one embodiment, a graphite or silicon/graphite anode and a LiCoO₂, LiNiMnCoO₂, or LiNiCoAlO₂ cathode may be used; however, any lithium ion battery anodes and cathodes may be employed with the solid electrolytes of the present invention. A detailed view of the solid electrolyte layer 100 is depicted in FIG. 1. In FIG. 1, solid electrolyte layer 120 includes a monomer 20 that can be UV-crosslinked to form a cross-linked polymer. A swelling polymer 30 is included within the UV-crosslinked matrix. Also included in this matrix is a lithium salt electrolyte dissolved within a solvent 50, particularly a high-boiling-point solvent. To provide mechanical strength to the solid electrolyte, ceramic particles 40 are provided. The strength of the solid electrolyte 100 is sufficient to prevent shorting of the cathode 110 and the anode 130 despite the absence of a separator in battery 100.

To enhance the use of the solid electrolyte in a wide variety of battery structures, precursors of the solid electrolyte 120 are both printable and UV-curable. In this way, precursors of the solid electrolyte may be printed on either the anode or the cathode in a variety of patterns. Further, the UV-curing of the precursor material forms a polymeric network that traps the lithium salt-in-solvent electrolyte inside a gel-like layer so that there is no liquid flow inside the battery package. The various components of the precursor material, exemplary materials used for these components, and methods of forming the precursor material are discussed in detail below.

A UV cross-linkable monomer is used as the basis for forming a cross-linked continuous network after being exposed to UV light, serving as a mechanical support for the solid electrolyte layer. The monomers used in the UV-curable materials of the present invention may be selected from any UV-curable monomer. Examples of such monomers include acrylic monomers such as trimethylolpropane ethoxylate, trimethylolpropane propoxylate triacrylate, or trimethylolpropane triacrylate. Polyethylene oxide and polyvinylidene fluoride-co-hexafluoropropylene may also be used, Examples of photoinitiators to be used with the monomers include 2-hydroxy-4′-(2-hydroxyethoxy)-2-methylpropiophenone, 2-hydroxy-2-methylpropiophenone, methylbenzoyl formate, 1-hydroxycyclohexyphenyl ketone, 2-methyl-4′-(methylthio)-2-morpholinopropiophenone, 4,4′-bis(dimethylamino)benzophenone, benzophenone, 2-Benzyl-2-(dimethylamino)-4′-morpholinobutyrophenone, and 4-hydroxybenzophenone. The ratio of monomer to photointiator may be on the order of 90 to 10 to 99 to 1.

The amount of monomer in the precursor solution is carefully controlled to create a sufficiently strong polymer matrix that is also sufficiently open to permit lithium ion transfer. When the amount of monomer is below approximately 4 wt %, insufficient cross-linking occurs to form a matrix; however, when the value exceeds approximately 15 wt %, a dense solid film is formed which resists lithium ion transfer.

Within the crosslinked network formed by the UV-curable monomer is a matrix of ion-conductive swelling polymers that is used for transferring lithium ions. The precursor solution preferably contains less than approximately 5 wt % of ion-conductive polymers prior to UV light irradiation. If the value exceeds 5 wt %, the high viscosity gel-like solution is likely to solidify after a short time due to the crystallization of polymers. Various ion conductive polymers may be used alone or in combination in the solid electrolyte layers of the present invention. Exemplary ion conductive polymers include polyethylene oxide, polyvinylidene fluoride-co-hexafluoropropyle, polyacrylonitrile, polyvinylidene fluoride, polymethyl methacrylate, or mixtures thereof. In one embodiment, polyethylene oxide may be selected as the primary ion-conductive polymer in an amount of approximately 70 to 90 percent of the total amount of ion conductive polymer material used. Polyethylene oxide has a molecular weight of about 10⁶ to 6×10⁶ to be able to trap the high boiling point solvents used for the electrolyte. The amount of ion-conductive polymers is balanced with the UV crosslinkable monomer to provide both good ionic conductivity and sufficient mechanical strength to prevent contact/shorting between the anode and cathode.

An electroactive material dissolved in an organic solvent is contained within the crosslinked polymer/ion conductive polymer structure. The organic solvent should be capable of both dissolving the electroactive material and should be stable at the working potential window of the lithium ion battery. At least one high boiling point solvent may be used. If low boiling point solvents are used, the solvent phase may evaporate during UV-curing process, creating a dense solid film with a very low lithium ion diffusion rate. Exemplary high boiling point solvents include ethylene carbonate, propylene carbonate, γ-butyroleactone, diethyl carbonate, and mixtures thereof.

Various electroactive materials may be used as the electrolyte. In an exemplary embodiment, the electroactive material is a lithium salt. Lithium salts that may be used include LiSCN, LiN(CN)₂, LiClO₄, LiBF₄, LiAsF₆, Li(CF)SO₂)₂N, Li(CF₃SO₂)₃C, LiN(SO₂C₂F₅)₂, LiN(SO₂CF₃)₂, LiN(SO₂CF₂CF₃)₂, lithium alkyl fluorophosphates, lithium oxalatoborate, lithium bis(trifluoromethane sulfone imide) (LiTFSI), LiPF₃(C₂F₅)₃, LiPF₃(CF₃)₃, LiB(C₂O₄)₂, and mixtures thereof in one embodiment, the electroactive material is a mixture of LiPF₆ and LiTFSI.

Ceramic particles are added to the precursor material so that they will be dispersed throughout the solid electrolyte layer. The purpose of adding ceramic nanofillers is to improve the electrolyte/electrodes interface by increasing the active surface area in the layer and to prevent the crystallization of the ion-conductive polymers. Various ceramic particles may be used in the precursor material/electrolyte layer. These include inert particles such Al₂O₃, TiO₂, SiO₂, or ZrO₂, or mixtures thereof. Alternatively, or in a mixture with these particles, may be ion conductive particles that increase the overall electroconductivity of the formed layer. An exemplary conductive particle is LiLaTiO3 (“LLTO”). In one embodiment, the ceramic particles are nanoparticles, have a particle size on the order of nanometers. The ceramic particles are added to the precursor solution in an amount of approximately 2-6 wt % based on the total mass of the precursor solution prior to UV curing. For values below 2 wt % there is no observed impact on battery performance, while values higher than approximately 6 wt % increase the viscosity of the precursor solution which adversely affects the printability of the precursor material, negatively impacting battery performance.

As stated previously, the precursor materials of the present invention are printable. Any printing technique may be used to deposit the precursor materials. Such techniques include screen printing, stencil printing, inkjet printing or doctor blade techniques. Printability of the electrolyte precursor material makes it ideal for applications requiring batteries with complicated shapes or curved surfaces.

Following printing, the deposited precursor material is UV cured at a wavelength determined according to the selected photoinitiator. The curing period is typically on the order of approximately 30 seconds; however, shorter or longer periods may be selected based on the thickness of the layer and the amount of monomer used in the precursor. Following UV exposure, the cured solid electrolyte layer is tacky; this adhesive property of the solid electrolyte layer may be used to adhere an electrode layer to the solid electrolyte, forming a unitary battery structure. Further, the adhesive property enhances the electrode-electrolyte interface for better ion transport.

### Example

To prepare the precursor material for the solid electrolyte layer, a 1 M solution of a mixture of lithium hexafluorophosphate (LiPF₆) and lithium bis(trifluoromethanesulfonyl)imide (LiTFSI) is formed in a mixture of ethylene carbonate, dimethyl carbonate, diethyl carbonate and acetonitrile as the organic solvents. A blend of ion conductive polymers including polyethene oxide and polyvinylidene fluoride is then dissolved in the solution. Then, 10 weight percent of trimethylolpropane ethoxylate as a crosslinkable monomer and 2-hydroxy-2-methylpropiophenone as a photo-initiator at a monomer/photoinitiator weight ratio of 90 to 10 and 2 weight percent of Al₂O₃ ceramic nanofillers are then added to the viscous solution and a uniform dispersion of the ceramic particles is obtained using a Thinky mixer for a time of three minutes. The gel-like precursor material is coated onto an electrode. UV light at a wavelength of 254 nm for matching for the excitation of the photo-initiator is irradiated on the coated layer to form a solid electrolyte.

To assemble a lithium ion battery, pouch cells with graphite anodes and LiCoO₂ cathodes are prepared using the precursor material. Electrodes are cut into a desired shape and size. Alternatively, electrodes may be printed. A graphite/carbon-based electrode may be used as the substrate for deposition of the precursor material. After UV exposure, the film is sticky enough to hold the cathode on the surface of the solid electrolyte layer. Multiple layers may be formed by stacking/printing additional electrode layers/precursor material layers to form multiple cells with higher capacity. Electrical terminals may be welded (or deposited) and the entire assembly may be sealed within a packaging material.

In some embodiments, the thickness of the solid electrolyte layer following UV irradiation is on the order of 400 μm or less. In testing, the solid electrolyte layer can withstand at least 1000 repeated bend cycles with a bending radius of 2 cm. The solid electrolyte layer is stable at potentials lower than about 4.35 V. Using a solid electrolyte layer increases the safety of the resultant battery since there is no liquid electrolyte that can leak out as demonstrated by nail penetration tests and short-circuit tests of lithium ion pouch cells employing the inventive solid electrolyte layer. Further, the resultant batteries demonstrate lower operating temperatures compared to reference cells using conventional liquid electrolytes. However, the batteries show comparable performance to batteries with liquid electrolytes and separator with respect to stable cyclic performance (charging/discharging).

FIG. 3 shows a typical electrochemical impedance spectroscopy (EIS) curve used for ionic conductivity measurement. The solid electrolyte layer of the present invention is sandwiched between two layers of stainless steel and the following equation is used to calculate the ionic conductivity:

σ=t/RA (σ: ionic conductivity, t: thickness and A: area of the electrolyte film)

The ionic conductivity of the said solid electrolyte is calculated as 6×10⁻³ S/cm at room temperature. This high ionic conductivity of the electrolyte layer boosts the electrochemical reactions leading to a good cell performance. The typical charge/discharge curve of a solid state Li-ion cell made with the solid electrolyte layer of the present invention is shown in FIG. 4. The battery shows excellent cyclic performance and a capacity retention of more than 95% after 300 cycles of charge and discharge.

The present invention discloses a UV-curable solid electrolyte for lithium ion batteries and a method to fabricate a lithium ion battery. The solid electrolyte layer includes a lithium salt dissolved in an organic solvent, ion-conductive polymers, UV cross-linked polymer eliminates the need for a separator, a battery manufacturing process step is eliminated, leading to a lower cost. The invention increases the safety of the battery especially at higher temperatures compared to conventional liquid electrolytes without significantly sacrificing the cell performance. Moreover, using this technology, a fully printable and bendable Li-ion battery can be formed which is ideal for many applications requiring safety at high-temperatures or having curved surfaces. Moreover, batteries with complicated shapes can be easily printed and integrated with other components which make it very attractive for printed electronic industry. The lithium ion battery made with the solid electrolyte layers of the invention is bendable and shows high capacity owing to the high ionic conductivity of the electrolyte layer, approximately 6×10⁻³ S/cm at room temperature.

It should be apparent to those skilled in the art that many modifications besides those already described are possible without departing from the inventive concepts herein. The inventive subject matter, therefore, is not to be restricted except in the spirit of the disclosure. Moreover, in interpreting the disclosure, all terms should be interpreted in the broadest possible manner consistent with the context. In particular, the terms “includes”, “including”, “comprises” and “comprising” should be interpreted as referring to elements, components, or steps in a non-exclusive manner, indicating that the referenced elements, components, or steps may be present, or utilized, or combined with other elements, components, or steps that are not expressly referenced.

1. A lithium ion battery having a UV-curable and printable solid electrolyte comprising:
a cathode including a lithium-based material selected from the group consisting of lithium manganese oxide (LMO), lithium cobalt oxide (LCO), and lithium nickel manganese cobalt oxide (NMC);
an anode selected from the group consisting of graphene, graphite, a silicon compound, and a silicon carbon composite;
a UV-curable and printable solid electrolyte positioned on at least one electrode, the UV-curable and printable solid electrolyte comprising:
a UV-curable and printable solid electrolyte precursor material comprising:
a lithium salt dissolved in one or more organic solvents;
a UV-curable monomer in an amount from approximately 4 weight percent to approximately 10 weight percent of the precursor material;
a UV photoinitiator, wherein the weight ratio of the UV-curable monomer to the UV photoinitiator is approximately 90 to 10 to approximately 99 to 1;
one or more host ion conductive polymers in an amount less than approximately 5 weight percent of the precursor material; and
ceramic particles, wherein the ceramic particles are selected from Al₂O₃, TiO₂, SiO₂, LLTO, or ZrO₂, or mixtures thereof; and
wherein the UV-curable and printable solid electrolyte precursor material, when cured, has sufficient mechanical rigidity to act as a separator preventing electrical shorting between the lithium ion battery cathode and the lithium ion battery anode and has sufficient electrical conductivity to function as an electrolyte for the lithium ion battery; and
wherein the thickness of the UV-curable and printable solid electrolyte is approximately 400 μm or less.

2. The lithium ion battery having a UV-curable and printable solid electrolyte of claim 1, wherein the one or more host ion conductive polymers are selected from polyethylene oxide, polyvinylidene fluoride-co-hexafluoropropyle, polyacrylonitrile, polyvinylidene fluoride, or polymethyl methacrylate.

3. The lithium ion battery having a UV-curable and printable solid electrolyte of claim 1, wherein the lithium salt is selected from LiSCN, LiN(CN)₂, LiClO₄, LiBF₄, LiAsF₆, LiCF₃SO₃, Li(CF₃SO₂)₂N, Li(CF₃SO₂)₃C, LiN(SO₂C₂F₅)₂, LiN(SO₂CF₃)₂, LiN(SO₂CF₂CF₃)₂, lithium alkyl fluorophosphates, lithium oxalatoborate, LiPF₃(C₂F₅)₃, LiPF₃(CF₃)₃, or LiB(C₂O₄)₂.

4. The lithium ion battery having a UV-curable and printable solid electrolyte of claim 1, wherein the lithium salt is selected from lithium hexafluorophosphate (LiPF₆) or lithium bis(trifluoromethanesulfonyl)imide (LiTFSI) or a mixture thereof

5. The lithium ion battery having a UV-curable and printable solid electrolyte of claim 1, wherein the ceramic particles are present in an amount from approximately 2 weight percent to approximately 6 weight percent.

6. The lithium ion battery having a UV-curable and printable solid electrolyte of claim 1, wherein the one or more solvents are selected from one or more of ethylene carbonate, dimethyl carbonate, diethylene carbonate, acetonitrile, or dimethylformamide.

7. The lithium ion battery having a UV-curable and printable solid electrolyte of claim 1, wherein the UV-curable monomer is selected from trimethylolpropane ethoxylate, trimethylolpropane propoxylate triacrylate, or trimethylolpropane triacrylate.

8. A method of making the lithium ion battery of claim 1 without a separator layer comprising:
printing a first electrode on a substrate;
printing the UV-curable precursor material on the first electrode;
UV curing the precursor material;
forming a second electrode in direct contact with cured precursor material;
sealing the first electrode, cured precursor material, and second electrode in a package.

9. The method of claim 8, wherein the first electrode is a cathode.

10. The method of claim 8, wherein the first electrode is an anode.

11. The method of claim 8, wherein the UV-curing time is less than approximately 30 seconds.

12. The method of claim 8, wherein the ionic conductivity of the cured precursor material is 6×10⁻³ S/cm.
